(19) United States
(12) Patent Application Publication
(10) Pub. No.: US 2011/0011689 A1
(43) Pub. Date: Jan. 20, 2011

(54) HYDRAULIC PRESSURE CONTROL APPARATUS FOR HYDRAULIC POWER TRANSMITTING DEVICE

(75) Inventor: Osamu SAKAMOTO, Handa-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/720,067

(22) Filed: Mar. 9, 2010

(30) Foreign Application Priority Data
Jul. 16, 2009 (JP) 2009-167807

(51) Int. Cl. F16D 33/08

(52) U.S. Cl. 192/3.3

(57) ABSTRACT

A hydraulic pressure control apparatus for a hydraulic power transmission, the hydraulic power transmission including a pump impeller configured to rotate, a turbine runner configured to rotate in response to fluid transmitted from the pump impeller, a lock-up clutch adapted to directly connect the turbine runner to a power source and an impeller clutch adapted to disconnect the pump impeller from the power source, wherein the hydraulic pressure control apparatus includes a switching valve provided at a fluid passage connecting the impeller clutch and a hydraulic pressure source and selectively connecting the impeller clutch to one of the hydraulic pressure source and a first control valve controlling a hydraulic pressure applied to the lock-up clutch.

### CROSS REFERENCE TO RELATED APPLICATIONS

This application is based on and claims priority under 35 U.S.C. §119 to Japanese Patent Application 2009-167807, filed on Jul. 16, 2009, the entire content of which is incorporated herein by reference.

### TECHNICAL FIELD

This disclosure relates to a hydraulic pressure control apparatus for a hydraulic power transmission for controlling hydraulic pressure applied to engaging elements of the hydraulic power transmission that has a mechanism adapted to disconnect a pump impeller from a power source.

### BACKGROUND DISCUSSION

Generally, automatic transmissions include, on a power transmission path between a power source and a transmission, a hydraulic power transmission configured by a torque converter or a fluid coupling adapted to transmit a torque from a power source continuously from a stall state to a directly connected state of an output shaft of the power source and an input shaft of the transmission. Further, a known hydraulic power transmissions disclosed in, for example JP2000-346135A and JP2004-301327A (US2004/0216971A), includes a mechanism configured to disconnect a pump impeller from a power source (i.e., hereinafter referred to as an impeller clutch) in order to eventually reduce the fuel consumption during an idling of an engine by reducing fluid resistance between the turbine runner and the pump impeller.

Another known hydraulic power transmission disclosed in, for example JP2003-42287A, includes a lock-up clutch adapted to eliminate a rotational speed difference between the power source and a turbine runner, by directly connecting the pump impeller to the turbine runner when a rotational speed difference between the pump impeller and the turbine runner is small, thereby eventually enhancing fuel economy when a vehicle is traveling. The lock-up clutch is controlled to be engaged or disengaged by a hydraulic pressure control of the hydraulic pressure control apparatus. The lock-up clutch may be a single plate clutch type which performs engagement and disengagement operations by a hydraulic pressure for transmitting a torque by means of fluid using two fluid passages or may be a multi-plate clutch type which is operated by supplying a hydraulic pressure for engagement which is different from the hydraulic pressure for transmitting the torque by means of the fluid using three fluid passages.

The hydraulic pressure circuit disclosed in JP2003-42287A may be applied to the hydraulic power transmission having an impeller clutch disclosed in JP2004-301327A or JP2003-346135A in order to control an engagement or disengagement of the impeller clutch.

However, with the hydraulic pressure circuit disclosed in JP2003-42287A, the lock-up clutch may not be surely engaged in case of a trouble, for example, a failure of a solenoid valve, an adhering of a control valve, and an adhering of a relay valve, or the like occurs. Thus, with the construction that the hydraulic pressure circuit, for example, disclosed in JP2003-42287A is applied to the hydraulic power transmission having the impeller clutch, for example, disclosed in JP2004-301327A or JP2000-346135A, in a case where a malfunction occurs in the hydraulic pressure circuit, the impeller clutch may not be surely engaged. The fact that the impeller clutch cannot be engaged connotes that there is a risk that power may not be sufficiently transmitted to the pump impeller.

A need thus exists for a hydraulic pressure control apparatus for a hydraulic power transmission, which is not susceptible to the drawback mentioned above.

### SUMMARY

According to an aspect of this disclosure, a hydraulic pressure control apparatus for a hydraulic power transmission, the hydraulic power transmission including a pump impeller configured to rotate, a turbine runner configured to rotate in response to fluid transmitted from the pump impeller, a lock-up clutch adapted to directly connect the turbine runner to a power source and an impeller clutch adapted to disconnect the pump impeller from the power source, wherein the hydraulic pressure control apparatus includes a switching valve provided at a fluid passage connecting the impeller clutch and a hydraulic pressure source and selectively connecting the impeller clutch to one of the hydraulic pressure source and a first control valve controlling a hydraulic pressure applied to the lock-up clutch.

### BRIEF DESCRIPTION OF THE DRAWINGS

The foregoing and additional features and characteristics of this disclosure will become more apparent from the following detailed description considered with the reference to the accompanying drawings, wherein:

FIG. 1 illustrates a configuration diagram schematically indicating a hydraulic pressure control apparatus for a hydraulic power transmission in a first embodiment;

FIG. 2 illustrates a configuration diagram schematically indicating a hydraulic pressure control apparatus for a hydraulic power transmission in a second embodiment;

FIG. 3 illustrates a configuration diagram schematically indicating a hydraulic pressure control apparatus for a hydraulic power transmission in a third embodiment;

FIG. 4 illustrates a configuration diagram schematically indicating a hydraulic pressure control apparatus for a hydraulic power transmission in a fourth embodiment;

FIG. 5A illustrates a configuration diagram schematically indicating a torque converter adapted to a hydraulic pressure control apparatus for a hydraulic power transmission in the fifth embodiment, the torque converter having a single-plate type lock-up clutch and a multi-plate type impeller clutch; and

FIG. 5B illustrates a configuration diagram schematically indicating a torque converter adapted to the hydraulic pressure control apparatus for the hydraulic power transmission in the fifth embodiment, the torque converter having a single-plate type lock-up clutch and a single-plate type impeller clutch.

### DETAILED DESCRIPTION

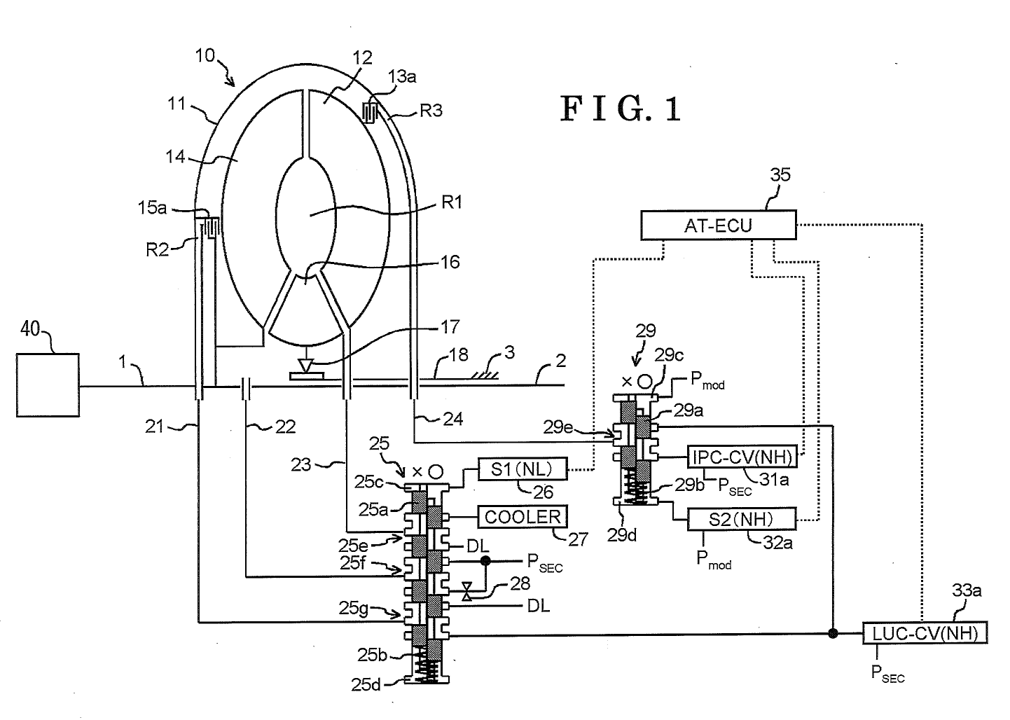

A hydraulic pressure control apparatus for a hydraulic power transmission of embodiments related to this disclosure will be described. The hydraulic pressure control apparatus controls the hydraulic power transmission that is configured by a pump impeller (12 in FIG. 1), a turbine runner (14 in FIG. 1), a lock-up clutch (15a in FIG. 1) and an impeller clutch (13a in FIG. 1). The turbine runner 14 is rotated in response to an oil flow caused by rotations of the pump impeller 12, the lock-up clutch 15a is operated so as to directly connect the turbine runner 14 to a power source 40 (e.g., an output shaft 1 in FIG. 1), and the impeller clutch 13a is operated so as to disconnect the pump impeller from the power source. The hydraulic pressure control apparatus includes a switching valve 29 that is provided on a fluid passage formed so as to connect the impeller clutch 13a to the hydraulic pressure source (e.g., a source of a secondary pressure (P_{SEC})) and is operated so as to selectively connect the impeller clutch to the hydraulic pressure source or a first control valve 33a controlling a hydraulic pressure applied to the lock-up clutch.

The hydraulic pressure control apparatus for the hydraulic power transmission of a first embodiment related to this disclosure will be described in accordance with the attached drawings. FIG. 1 illustrates a configuration diagram schematically indicating the hydraulic pressure control apparatus for the hydraulic power transmission in the first embodiment.

The hydraulic pressure control apparatus for the hydraulic power transmission of the first embodiment shown in FIG. 1 corresponds to a hydraulic pressure control apparatus for a torque converter 10 which includes the multi-plate type impeller clutch 13a configured to disconnect the pump impeller 12 from a converter shell 11 integrally rotating with a power source (e.g., an engine) 40. The hydraulic pressure control apparatus controls a hydraulic pressure applied to the impeller clutch 13a to engage the impeller clutch 13a to establish an engaging state by supplying the hydraulic pressure and to disengage the impeller clutch 13a by not supplying the hydraulic pressure. The hydraulic pressure control apparatus, with respect to the impeller clutch 13a, includes a lock-up clutch passage 21, an inlet side fluid passage 22, an outlet side fluid passage 23, an impeller clutch fluid passage 24, a lock-up relay valve 25 (e.g., a relay valve), a solenoid valve 26 (e.g., a second solenoid valve), a cooler 27, an orifice 28, the fail valve 29 (e.g., a switching valve), an impeller clutch controlling valve 31a (e.g., a second control valve), a solenoid valve 32a (e.g., a first solenoid valve), a lock-up clutch controlling valve 33a (e.g., a first control valve) and an electronic control unit 35.

The torque converter 10 is a hydraulic power transmission which generates torque multiplication by a rotational speed difference between the pump impeller 12 provided at an input side and the turbine runner 14 provided at an output side by applying hydrodynamic action. The torque converter 10 is disposed on a power transmission path between an output shaft 1 for the power source 40 and an input shaft 2 for a transmission. The torque converter 10 includes the converter shell 11, the pump impeller 12, the impeller clutch 13a, the turbine runner 14, the lock-up clutch 15a, a stator 16, a one-way clutch 17, a stator shaft 18, a hydraulic power transmitting chamber R1, a lock-up clutch hydraulic pressure chamber R2 and an impeller clutch hydraulic pressure chamber R3.

The converter shell 11 serves as a casing for the torque converter 10. The converter shell 11 normally rotates integrally with the output shaft 1 of the power source 40. Components of the torque converter 10 and an operational fluid (e.g., oil) are provided within the converter shell 11. The converter shell 11 is configured to relatively rotatable with the pump impeller 12 and to rotate integrally with the pump impeller 12 when the impeller clutch 13a is engaged thereto. The converter shell 11 is configured to relatively rotatable with the turbine runner 14 and to rotate integrally with the turbine runner 14 when the lock-up clutch 15a is engaged thereto.

The pump impeller 12 is an impeller which rotates to send the operational fluid to the turbine runner 14. The pump impeller 12 is configured to rotate relatively to the converter shell 11 and to integrally rotate with the converter shell 11 when the impeller clutch 13a is engaged to the pump impeller 12.

The impeller clutch 13a is a multi-plate clutch mechanism configured to disconnect the pump impeller 12 from the power source (e.g., engine) 40 in order to reduce the fluid resistance between the turbine runner 14 and the pump impeller 12, thereby reducing the fuel consumption during an idling of the engine. The impeller clutch 13a transmits a rotational force of the converter shell 11 to the pump impeller 12 when engaged. The impeller clutch 13a includes an input side clutch plate which is connected to the converter shell 11 not to be relatively rotatable but to be movable in an axial direction, and an output side clutch plate which is connected to the pump impeller 12 not to be relatively rotatable but to be movable in an axial direction, and a piston which is pushed out when a hydraulic pressure is applied to the impeller clutch hydraulic pressure chamber R3. The input side clutch plates and the output side clutch plates are arranged alternately to each other in the impeller clutch 13a, and the piston pushes the input side clutch plate to the output side clutch plate to frictionally engage the input side clutch plate and the output side clutch plate.

The turbine runner 14 is an impeller which rotates when receiving the operational fluid sent by the pump impeller 12. The turbine runner 14 always integrally rotates with the input shaft 2 of the transmission. The turbine runner 14 is configured to relatively rotatable with the converter shell 11 and to integrally rotate with the converter shell 11 when the lock-up clutch 15a is engaged.

The lock-up clutch 15a is a multi-plate clutch mechanism which eliminates the rotational speed difference between the power source (e.g., engine) 40 and the turbine runner 14 by directly connecting the pump impeller 12 to the turbine runner 14 when the rotational speed difference between the pump impeller 12 and the turbine runner 14 is small. When the lock-up clutch 15a is engaged, torque of the converter shell 11 is transmitted to the turbine runner 14. The lock-up clutch 15a includes an input side clutch plate which is connected to the converter shell 11 not to be relatively rotatable but to be movable in an axial direction, an output side clutch plate connected to the turbine runner 14 not to be relatively rotatable but to be movable in an axial direction, and a piston which is pushed out by applying the hydraulic pressure in the lock-up clutch hydraulic pressure chamber R2. The input side clutch plates and the output side clutch plates are arranged alternately to each other in the lock-up clutch 15a, and the piston pushes the input side clutch plate to the output side clutch plate to frictionally engage the input side clutch plate and the output side clutch plate.

The stator 16 is disposed between the turbine runner 14 and the pump impeller 12 closer to a radially inner portion of the torque converter 10 and corresponds to an impeller which generates torque multiplication by adjusting and returning the operational fluid discharged from the turbine runner 14 to the pump impeller 12. The stator 16 is fixed to a transmission case 3 via the one-way clutch 17 and the stator shaft 18 and is configured to rotate only in one direction.

The one-way clutch 17 allows the stator 16 to rotate only in one direction. The stator 16 is fixed to a rotational end of the one-way clutch 17. A fixed end of the one-way clutch 17 is fixed to the transmission case 3 via the stator shaft 18.

The stator shaft 18 is a shaft member for fixing the fixed end of the one-way clutch 17 to the transmission case 3.

The hydraulic power transmission chamber R1 accommodates the pump impeller 12, the turbine runner 14, and the stator 16, and is filled with the operational fluid. The hydraulic pressure is applied to the hydraulic power transmission chamber R1 via the inlet side fluid passage 22 and the hydraulic pressure is discharged from the hydraulic power transmission chamber R1 via the outlet side fluid passage 23.

The lock-up clutch hydraulic pressure chamber R2 is arranged for operating the lock-up clutch 15a. The lock-up clutch hydraulic pressure chamber R2 is connected to the lock-up clutch passage 21. In a case where a hydraulic pressure higher than a hydraulic pressure in the hydraulic power transmission chamber R1 is applied to the lock-up clutch hydraulic pressure chamber R2, the lock-up clutch 15a is engaged, and the lock-up clutch 15a is released in a case where a hydraulic pressure in the lock-up clutch hydraulic pressure chamber R2 is lower than a hydraulic pressure in the hydraulic power transmission chamber R1.

The impeller clutch hydraulic pressure chamber R3 is arranged for operating the multi-plate impeller clutch 13a. The impeller clutch hydraulic pressure chamber R3 is connected to the impeller clutch fluid passage 24. In a case where a hydraulic pressure higher than a hydraulic pressure in the hydraulic power transmission chamber R1 is applied to the impeller clutch hydraulic pressure chamber R3, the impeller clutch 13a is engaged, and the impeller clutch 13a is released in a case where a hydraulic pressure in the impeller clutch hydraulic pressure chamber R3 is lower than a hydraulic pressure in the hydraulic power transmission chamber R1.

The lock-up clutch passage 21 is a fluid passage by which the lock-up clutch hydraulic pressure chamber R2 is connected to a switching portion 25g of the lock-up relay valve 25. The inlet side fluid passage 22 is a fluid passage by which a hydraulic pressure from a switching portion 25f of the lock-up relay valve 25 is applied to the hydraulic power transmitting chamber R1 of the torque converter 10. The outlet side fluid passage 23 is a fluid passage by which a hydraulic pressure from the hydraulic power transmitting chamber R1 of the torque converter 10 is applied to a switching portion 25e of the lock-up relay valve 25. The impeller clutch fluid passage 24 is a fluid passage by which the impeller clutch hydraulic pressure chamber R3 is connected to a switching portion 29e of the fail valve 29.

The lock-up relay valve 25 is a switching valve for switching (e.g., selecting) a fluid passage to be used. The lock-up relay valve 25 formed with a valve body within which a spool 25a, a spring 25b, a hydraulic pressure chamber 25c, a spring chamber 25d and the switching portions 25e, 25f and 25g are housed. The spool 25a is arranged so as to be slidable within the valve body, and the spring 25b is arranged within the spring chamber 25d so as to bias the spool 25a toward the hydraulic pressure chamber 25c. The hydraulic pressure chamber 25c is operated so as to press the spool 25a toward the spring chamber 25d when a hydraulic pressure based on an ON/OFF signal of the solenoid valve 26 is applied thereto. The spring chamber 25d houses the spring 25b. The spool 25a slides toward the spring chamber 25d (in a state indicated by “o” in FIG. 1) when the pressing force generated within the hydraulic pressure chamber 25c is greater than the biasing force of the spring 25b and slides toward the hydraulic pressure chamber 25c (in a state indicated by “x” in FIG. 1) when the pressing force generated within the hydraulic pressure chamber 25c is lower than the biasing force of the spring 25b. The lock-up relay valve 25 includes the switching portion 25e by which the outlet side fluid passage 23 selectively communicates with either one of the cooler 27 and a drain port (DL). Specifically, the switching portion 25e establishes a communication between the outlet side fluid passage 23 and the cooler 27 when the lock-up relay valve 25 is in the state indicated by “x” in FIG. 1 and establishes a communication between the outlet side fluid passage 23 and the drain port (DL) when the lock-up relay valve 25 is in the state indicated by “o” in FIG. 1. The lock-up relay valve 25 further includes the switching portion 25f by which the inlet side fluid passage 22 communicates with an input port of a secondary pressure (P_{SEC}). Specifically, the switching portion 25f establishes a communication between the inlet side fluid passage 22 and the input port of the secondary pressure (P_{SEC}) when the lock-up relay valve 25 is in the state indicated by “x” in FIG. 1 and establishes a communication between the inlet side fluid passage 22 and the input port of the secondary pressure (P_{SEC}) via the orifice 28 when the lock-up relay valve 25 is in the state indicated by “o” in FIG. 1. The lock-up relay valve 25 includes the switching portion 25g by which the lock-up clutch passage 21 selectively communicates with either one of a drain port (DL) and the lock-up clutch controlling valve 33a. Specifically, the switching portion 25g establishes a communication between the lock-up clutch passage 21 and the drain port (DL) when the lock-up relay valve 25 is in the state indicated by “x” in FIG. 1 and establishes a communication between the lock-up clutch passage 21 and the lock-up clutch controlling valve 33a when the lock-up relay valve 25 is in the state indicated by “o” in FIG. 1. Here, the secondary pressure (P_{SEC}) corresponds to a hydraulic pressure that is adjusted by reducing the hydraulic pressure outputted from an oil pump (i.e., line pressure).

The solenoid valve 26 is an on/off type solenoid valve for controlling an application of a hydraulic pressure to the hydraulic pressure chamber 25c of the look-up relay valve 25 in response to a state of the solenoid valve 26 (a conducted or non-energized state). Specifically, the solenoid valve 26 has a normally low (NL) characteristic where a hydraulic pressure is outputted when the solenoid valve 26 is in the energized state and the hydraulic pressure is not outputted when the solenoid valve 26 is in the non-energized state. The solenoid valve 26 is controlled by the electronic control unit 35. A linear type solenoid valve, by which a level of a hydraulic pressure may be adjusted in accordance with an electrical current amount, may be used instead of the on/off type solenoid valve 26.

The cooler 27 is an instrument by which a temperature of the operational fluid within the hydraulic pressure circuit is reduced. The operational fluid is cooled by the cooler 27 as follows. The operational fluid discharged from the switching portion 25e of the lock-up relay valve 25 flows in the cooler 27 via the fluid passage, and the operational fluid emits its heat at the cooler 27, and the operational fluid whose temperature is reduced is discharged to an oil pan.

The orifice 28 is used to regulate (control) an amount of the secondary pressure (P_{SEC}). The operational fluid passing through the orifice 28 flows toward the switching portion 25f of the lock-up relay valve 25.

The fail valve 29 is a valve for switching (e.g., selecting) a fluid passage to be used. Specifically, the fail valve 29 is provided on a passage connecting the impeller clutch 13a to the impeller clutch controlling valve 31a and establishes a communication between the impeller clutch fluid passage 24 with either one of the impeller clutch controlling valve 31a and the lock-up clutch controlling valve 33a. The fail valve 29 is formed with a valve body within which the spool 29a, a spring 29b, a hydraulic pressure chamber 29c, a spring chamber 29d and switching portions 29e are housed. The spool 29a is arranged so as to be slidable within the valve body, and the spring 29b is arranged within the spring chamber 29d so as to bias the spool 29a toward the hydraulic pressure chamber 29c. The hydraulic pressure chamber 29c is configured to normally act, by receiving a constant modulator pressure (P_{mod}) that is normally introduced thereto, so as to press the spool 29a toward the spring chamber 29d. The spring chamber 29d houses the spring 29b and is configured to normally act so as to press the spool 29a toward the hydraulic pressure chamber 29c when a hydraulic pressure based on ON/OFF signal of the solenoid valve 32a is applied. The spool 29a slides toward the spring chamber 29d (in a normal state indicated by “o” in FIG. 1) when the modulator pressure (P_{mod}) generated within the hydraulic pressure chamber 29c is greater than a total of the biasing force of the spring 29b and a pressing force on the basis of the hydraulic pressure generated within the spring chamber 29d (a pressure based on the solenoid valve 32a), and the spool 29a slides toward the hydraulic pressure chamber 29c (in a fail state indicated by “x” in FIG. 1) when the modulator pressure (P_{mod}) generated within the hydraulic pressure chamber 29c is lower than the total of the biasing force of the spring 29b and a pressing force on the basis of the hydraulic pressure generated within the spring chamber 29d (the pressure based on the solenoid valve 32a). The fail valve 29 includes the switching portion 29e by which the impeller clutch fluid passage 24 selectively communicates with either one of the lock-up clutch controlling valve 33a and the impeller clutch controlling valve 31a. Specifically, the fail valve 29 establishes a communication between the impeller clutch fluid passage 24 and the lock-up clutch controlling valve 33a when the fail valve 29 is in the fail state indicated by “x” in FIG. 1 and establishes a communication between the impeller clutch fluid passage 24 and the impeller clutch controlling valve 31a when the fail valve 29 is in the normal state indicated by “o” in FIG. 1. Here, the modulator pressure (P_{mod}) corresponds to a hydraulic pressure that is adjusted by reducing the hydraulic pressure outputted from an oil pump (i.e., line pressure).

The impeller clutch controlling valve 31a is a linear solenoid valve for outputting the hydraulic pressure by adjusting the hydraulic pressure of the hydraulic pressure source (e.g., the secondary pressure (P_{SEC})) on the basis of an electric current supplied thereto.

The impeller clutch controlling valve 31a is a normally high (NH) valve. Specifically, the impeller clutch controlling valve 31a is configured not to output or outputs a hydraulic pressure by reducing the secondary pressure (P_{SEC}) when the electric current is supplied to the impeller clutch controlling valve 31a (e.g., an energized state). Further, the impeller clutch controlling valve 31a is configured to output the secondary pressure (P_{SEC}) when the electric current is not supplied to the impeller clutch controlling valve 31a (e.g., a non-energized state). The impeller clutch controlling valve 31a is controlled by the electronic control unit 35. The impeller clutch controlling valve 31a may be any valve such as a linear solenoid valve, an ON/OFF solenoid valve, a pressure-adjusting valve or the like as long as it may execute an ON/OFF control of the hydraulic pressure.

The solenoid valve 32a is a linear solenoid valve that is adapted to control a hydraulic pressure applied to the spring chamber 29d of the fail valve 29 on the basis of the electric current supplied thereto. The solenoid valve 32a is a normally high (NH) valve. Specifically, the solenoid valve 32a is configured not to output a hydraulic pressure or outputs a hydraulic pressure by reducing the modulator pressure (P_{mod}) when the electric current is supplied to the solenoid valve 32a (e.g., an energized state). Further, the solenoid valve 32a is configured to output a hydraulic pressure corresponding to the modulator pressure (P_{mod}) when the electric current is not supplied to the solenoid valve 32a (e.g., a non-energized state). The solenoid valve 32a is used in a case where the device for outputting the modulator pressure (P_{mod}) fails. The solenoid valve 32a is controlled by the electronic control unit 35.

The lock-up clutch controlling valve 33a is a linear solenoid valve for outputting a hydraulic pressure by adjusting the hydraulic pressure of the hydraulic pressure source (e.g., the secondary pressure (P_{SEC})) on the basis of an electric current supplied thereto. The lock-up clutch controlling valve 33a is a normally high (NH) valve. Specifically, the lock-up clutch controlling valve 33a is configured not to output a hydraulic pressure or to output a hydraulic pressure by reducing the secondary pressure (P_{SEC}) when the electric current is supplied to the lock-up clutch controlling valve 33a (e.g., an energized state). Further, the lock-up clutch controlling valve 33a is configured to output the secondary pressure (P_{SEC}) when the electric current is not supplied to the lock-up clutch controlling valve 33a (e.g., a non-energized state). The lock-up clutch controlling valve 33a is controlled by the electronic control unit 35. The lock-up clutch controlling valve 33a may be any valve such as a linear solenoid valve, an ON/OFF solenoid valve, a pressure-adjusting valve or the like as long as it may execute an ON/OFF control of the hydraulic pressure.

The electronic control unit 35 is a computer that controls an operation of the solenoid valve 26, the impeller clutch controlling valve 31a, the solenoid valve 32a and the lock-up clutch controlling valve 33a. The electronic control unit 35 performs information processing by executing a predetermined program (i.e., including a data base, a map, or the like) on the basis of signals sent from various sensors of a vehicle. The electronic control unit 35 judges whether the engine is idling or not, and when the electronic control unit 35 judges that the engine is idling, the electronic control unit 35 controls the impeller clutch 13a to be disengaged in order to reduce the fluid resistance between the turbine runner 14 and the pump impeller 12. Controlling operations of the electronic control unit 35 will be explained in more details hereinafter.

An actuation of the hydraulic pressure control apparatus of the hydraulic power transmission of the first embodiment will be explained as follows.

[Normal Operation]

When the hydraulic pressure control apparatus is normally actuated, the electronic control unit 35 controls the solenoid valve 32a so as to be in the energized state for sliding the spool 29a of the fail valve 29 toward the spring chamber 29d (moved so as to be in the state indicated by “o” in FIG. 1 so that the spring 29b is compressed), thereby communicating the impeller clutch 13a with the impeller clutch controlling valve 31a. In this sate, the impeller clutch controlling valve 31a is controlled by the electronic control unit 35 in order to connect/disconnect the impeller clutch 13a. Specifically, the impeller clutch 13a is turned in the engaging state by controlling the impeller clutch controlling valve 31a so that a level of the hydraulic pressure within the impeller clutch hydraulic pressure chamber R3 is greater than that of the hydraulic power transmitting chamber R1, on the other hand, the impeller clutch 13a is turned in the disengaging state by controlling the impeller clutch controlling valve 31a so that a level of the hydraulic pressure within the impeller clutch hydraulic pressure chamber R3 is lower than that of the hydraulic power transmitting chamber R1. In this configuration, the fluid resistance between the turbine runner 14 and the pump impeller 12 within the torque converter 10 is reduced by disengaging the impeller clutch 13a when the engine is in the idling state.

[Actuation when a Failure Occurs at Impeller Clutch Controlling Valve so as not to Output Hydraulic Pressure]

When a failure occurs at the impeller clutch controlling valve 31a so as not to output a hydraulic pressure, the electronic control unit 35 controls the solenoid valve 32a so as to be in the non-energized state (a fail area) in order to slide the spool 29a of the fail valve 29 so as to be in the state indicated by “x” in FIG. 1, thereby communicating the impeller clutch 13a with the lock-up clutch controlling valve 33a. At this point, the lock-up clutch controlling valve 33a is controlled by the electronic control unit 35 so as to engage/disengage the impeller clutch 13 in the same manner as the normal actuation where the impeller clutch 13a is turned in the engaging state by controlling the impeller clutch controlling valve 31a so that a level of the hydraulic pressure within the impeller clutch hydraulic pressure chamber R3 is greater than that of the hydraulic power transmitting chamber R1, on the other hand, the impeller clutch 13a is turned in the disengaging state by controlling the impeller clutch controlling valve 31a so that a level of the hydraulic pressure within the impeller clutch hydraulic pressure chamber R3 is lower than that of the hydraulic power transmitting chamber R1. In this state, because the lock-up clutch 15a needs to be in a disengaging state in order to prevent an engine stall, the electronic control unit 35 controls the solenoid valve 26 so as to be in the non-energized state for sliding the spool 25a toward the hydraulic pressure chamber 29c (moved so as to be in the state indicated by “x” in FIG. 1 so that the spring 29b is extended), thereby disconnecting the lock-up clutch 15a from the lock-up clutch controlling valve 33a. Accordingly, the lock-up clutch 15a may be turned in a disengaging state.

[Actuation when Failure Occurs at Fail Valve]

When a failure occurs at the fail valve 29 so as to be in the state indicated by “x” in FIG. 1 where the spring 29b is extended or in the state indicated by “o” in FIG. 1 where the spring 29b is compressed, because either one of the impeller clutch controlling valve 31a and the lock-up clutch controlling valve 33a communicates with the impeller clutch 13a, the electronic control unit 35 may control either one of the impeller clutch controlling valve 31a and the lock-up clutch controlling valve 33a, thereby engaging/disengaging the impeller clutch 13a. When the impeller clutch 13a is controlled by the lock-up clutch controlling valve 33a so as to be engaged/disengaged, because the lock-up clutch 15a needs to be in a disengaging state in order to prevent an engine stall, the electronic control unit 35 controls the solenoid valve 26 so as to be in the non-energized state for sliding the spool 25a toward the hydraulic pressure chamber 29c (moved so as to be in the state indicated by “x” in FIG. 1 so that the spring 29b is extended), thereby disconnecting the lock-up clutch 15a from the lock-up clutch controlling valve 33a. Accordingly, the lock-up clutch 15a may be turned in a disengaging state.

[Actuation when Failure Occurs at Solenoid Valve 32a]

When a failure occurs at the solenoid valve 32a so as to remain in a state where a hydraulic pressure is outputted or remain in a state where a hydraulic pressure is not outputted, because either one of the impeller clutch controlling valve 31a and the lock-up clutch controlling valve 33a communicates with the impeller clutch 13a, the electronic control unit 35 may control either one of the impeller clutch controlling valve 31a and the lock-up clutch controlling valve 33a, thereby engaging/disengaging the impeller clutch 13a. When the impeller clutch 13a is controlled by the lock-up clutch controlling valve 33a so as to be engaged/disengaged, because the lock-up clutch 15a needs to be in a disengaging state in order to prevent the engine stall, the electronic control unit 35 controls the solenoid valve 26 so as to be in the non-energized state for sliding the spool 25a toward the hydraulic pressure chamber 29c (moved so as to be in the state indicated by “x” in FIG. 1 so that the spring 29b is extended), thereby disconnecting the lock-up clutch 15a from the lock-up clutch controlling valve 33a. Accordingly, the lock-up clutch 15a may be turned in a disengaging state.

[Actuation upon Electric Power Supply Malfunction]

When a failure occurs at the electric power supply so as not to supply the electric power to the electronic control unit 35 or the like, by virtue of a normally high (NH) characteristic of the solenoid valve 32a, the spool 29a of the fail valve 29 slides so as to be in the state indicated by “x” where the spring 29b is extended, thereby communicating the impeller clutch 13a with the lock-up clutch controlling valve 33a. At this point, even when the electric current is not supplied to the lock-up clutch controlling valve 33a, because of the normally high (NH) characteristic of the solenoid valve 32a, the hydraulic pressure is outputted by the lock-up clutch controlling valve 33a, thereby engaging the impeller clutch 13a so that the vehicle is able to be driven. Further, by virtue of a normally low characteristic of the solenoid valve 26, the spool 25a of the lock-up relay valve 25 slides so as to be in the state indicated by “x” where the spring 25b is extended, accordingly the lock-up clutch 15a is disconnected from the lock-up clutch controlling valve 33a, thereby disengaging the lock-up clutch 15a.

According to the first embodiment, even when failures occur at the impeller clutch controlling valve 31a, the fail valve 29 and the solenoid valve 32a, which are components of the hydraulic pressure control apparatus for the hydraulic power transmission, the impeller clutch 13a may be engaged/disengaged in a same manner as a normal operation, accordingly a loss of fuel economy may be prevented. Further, even when the electric power supply malfunctions so as not to supply the electric power to the electronic control unit 35 or the like, the impeller clutch 13a is engaged so that a situation where the vehicle is not able to be driven may be avoided.

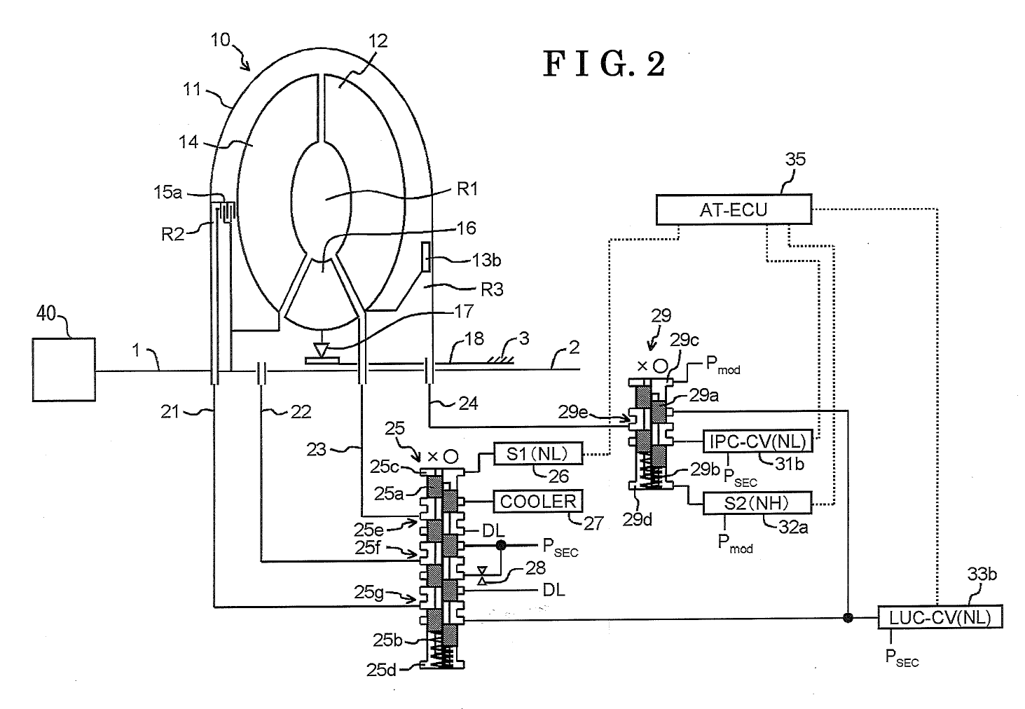

The hydraulic pressure control apparatus for the hydraulic power transmission of a second embodiment related to this disclosure will be described in accordance with the attached drawings. FIG. 2 illustrates a configuration diagram schematically indicating the hydraulic pressure control apparatus for the hydraulic power transmission in the second embodiment.

A hydraulic pressure control apparatus for the hydraulic power transmission in the second embodiment includes a single-plate type impeller clutch 13b while the hydraulic pressure control apparatus in the first embodiment includes the multi-plate type impeller clutch 13a.

The hydraulic pressure control apparatus for the hydraulic power transmission of the second embodiment shown in FIG. 2 corresponds to a hydraulic pressure control apparatus for a torque converter 10 which includes the single-plate type impeller clutch 13b configured to disconnect the pump impeller 12 from the converter shell 11 integrally rotating with the power source (e.g., engine) 40. The hydraulic pressure control apparatus controls a hydraulic pressure applied to the impeller clutch 13b to engage the impeller clutch 13b (e.g., establishing an engaging state) by not supplying the hydraulic pressure thereto and to disengage the impeller clutch 13b (e.g., establishing a disengaging state) by supplying the hydraulic pressure. The hydraulic pressure control apparatus of the second embodiment in FIG. 2 has a configuration basically similar to that of the first embodiment, where the impeller clutch controlling valve 31a is changed to a impeller clutch controlling valve 31b (e.g., the second control valve) that has a normally low characteristic, and the lock-up clutch controlling valve 33a in the first embodiment is changed to a lock-up clutch controlling valve 33b (e.g., the first control valve) that has a normally low characteristic.

The torque converter 10 indicated in FIG. 1 has a configuration basically similar to the torque converter 10 in FIG. 1 of the first embodiment where the multi-plate type impeller clutch 13a is changed to the single-plate type impeller clutch 13b, and other components and structure are similar to the torque converter 10 in the first embodiment.

The impeller clutch 13b is a single-plate type clutch mechanism for transmitting rotational power of the converter shell 11 to the pump impeller 12 when the impeller clutch 13b is in the engaging state. The impeller clutch 13b includes a single-plate type clutch plate fixed to a member integrally rotating with the pump impeller 12. When a level of hydraulic pressure in the hydraulic power transmitting chamber R1 is higher than that in the impeller clutch hydraulic pressure chamber R3, the clutch plate pressingly contacts an inner wall surface of the converter shell 11 so as to be frictionally engagable for establishing the engaging state. On the other hand, when the level of the hydraulic pressure in the impeller clutch hydraulic pressure chamber R3 is higher than that in the hydraulic power transmitting chamber R1, the clutch plate disengages from the converter shell 11 so as to be relatively rotatable for establish the disengaging state.

The impeller clutch hydraulic pressure chamber R3 is a hydraulic pressure chamber used for actuating the single-plate type impeller clutch 13b. The impeller clutch hydraulic pressure chamber R3 is connected to the impeller clutch fluid passage 24. When the hydraulic pressure lower than that in the hydraulic power transmitting chamber R1 is applied to the impeller clutch hydraulic pressure chamber R3, the impeller clutch 13b is turned into the engaging state, on the other hand, when the hydraulic pressure in the impeller clutch hydraulic pressure chamber R3 becomes higher than that in the hydraulic power transmitting chamber R1, the impeller clutch 13b is turned to be in the disengaging state.

The impeller clutch control valve 31b is a linear solenoid valve for outputting hydraulic pressure from the hydraulic pressure source (e.g., the secondly pressure P_{SEC}) by modulating in accordance with the electric current supplied thereto. Specifically, the impeller clutch controlling valve 31b has a normally low (NL) characteristic where the impeller clutch controlling valve 31b outputs hydraulic pressure by reducing the secondary pressure (P_{SEC}) when the impeller clutch control valve 31b is in an energized state, on the other hand, the impeller clutch controlling valve 31b does not output the hydraulic pressure when the impeller clutch control valve 31b is in a non-energized state. The impeller clutch control valve 31b may be any valve such as a linear solenoid valve, an ON/OFF solenoid valve, a pressure-adjusting valve or the like as long as it may execute an ON/OFF control of the hydraulic pressure.

The lock-up clutch controlling valve 33b is a linear solenoid valve for outputting hydraulic pressure from the hydraulic pressure source (e.g., the secondly pressure P_{SEC}) by modulating in accordance with the electric current applied thereto. Specifically, the lock-up clutch controlling valve 33b has a normally low (NL) characteristic where the lock-up clutch controlling valve 33b outputs a hydraulic pressure by reducing the secondary pressure (P_{SEC}) when the lock-up clutch controlling valve 33b is in an energized state, on the other hand, the lock-up clutch controlling valve 33b does not output the hydraulic pressure when the lock-up clutch controlling valve 33b is in a non-energized state. The lock-up clutch controlling valve 33b may be any valve such as a linear solenoid valve, an ON/OFF solenoid valve, a pressure-adjusting valve or the like as long as it may execute an ON/OFF control of the hydraulic pressure.

According to the second embodiment, because both of the impeller clutch control valve 31b and the lock-up clutch controlling valve 33b have the normally low characteristics, the electronic control unit 35 executes the control on the basis of the normally low characteristics. The normally low characteristic of the solenoid valve 26, the normally high characteristic of the solenoid valve 32a and the configuration of the fail valve 29 are the same as in the first embodiment (see FIG. 1).

An actuation of the hydraulic pressure control apparatus for the hydraulic power transmission in the second embodiment will be explained. In order to establish the engaged state of the single-plate type impeller clutch 13b, the impeller clutch controlling valve 31b and the lock-up clutch controlling valve 33b, each of which has the normally low (NL) characteristic, are controlled in such a way that the level of the hydraulic pressure within the impeller clutch hydraulic pressure chamber R3 is lower than that in the hydraulic power transmitting chamber R1. Other actuations are similar to those in the first embodiment.

According to the second embodiment, in the same manner as in the first embodiment, even when a failure occurs at the impeller clutch controlling valve 31b, the fail valve 29 or the solenoid valve 32a, the impeller clutch 13a may be controlled so as to be in the engaged/disengaging state in the same manner as the normal operation, accordingly a loss of fuel economy may be prevented. Further, even when the electric power supply malfunctions so as not to supply the electric power to the electronic control unit 35 or the like, the impeller clutch 13a is engaged so that a situation where the vehicle is not able to be driven may be avoided.

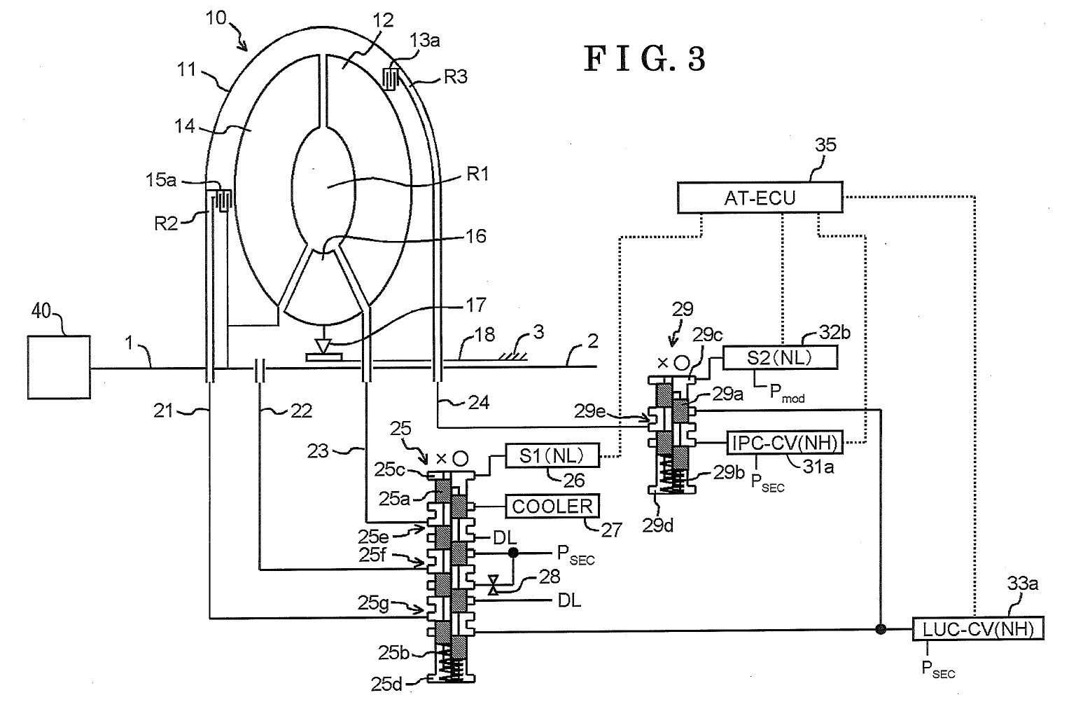

The hydraulic pressure control apparatus for the hydraulic power transmission of a third embodiment related to this disclosure will be described in accordance with the attached drawings. FIG. 3 illustrates a configuration diagram schematically indicating the hydraulic pressure control apparatus for the hydraulic power transmission in the third embodiment.

In the first embodiment, the fluid passage to the impeller clutch fluid passage (24 in FIG. 1) is switched (selected) by controlling the modulator pressure (P_{mod}) applied to the hydraulic pressure chamber (29c in FIG. 1) of the fail valve (29 in FIG. 1) and by controlling the hydraulic pressure being set on the basis of the signal of the solenoid valve (32a in FIG. 1) having the normally high (NH) characteristic so as to be applied to the spring chamber (29d in FIG. 1). In the third embodiment, a fail valve 29 is configured in such a way that a hydraulic pressure corresponding to a signal of a normally low solenoid valve 32b (e.g., the first solenoid valve) is applied to a hydraulic pressure chamber 29c of the fail valve 29, and a fluid passage connected to the impeller clutch fluid passage 24 is switched (selected) by controlling a level of the hydraulic pressure being set on the basis of the signal of the solenoid valve 32b. Other configurations are basically similar to those in the first embodiment. In the third embodiment, the hydraulic pressure control apparatus for the hydraulic power transmission is configured to correspond the multi-plate type impeller clutch 13a, and both of the impeller clutch controlling valve 31a and the lock-up clutch controlling valve 33a have normally high (NH) characteristics in the same manner as the first embodiment.

The fail valve 29 includes the hydraulic pressure chamber 29c acting so as to press a spool 29a toward a spring chamber 29d by applying hydraulic pressure corresponding to the signal of the solenoid valve 32b. The fail valve 29 includes the spring chamber 29d in which a spring 29b is accommodated. The spring chamber 29d is configured so as not to be controlled by the hydraulic pressure. The spool 29a slides toward the spring chamber 29d (switched to a normal state “o”) when a level of the hydraulic pressure corresponding to the signal of the solenoid valve 32b is higher than a level of the biasing force generated by the spring 29b, and the spool 29a slides toward the hydraulic pressure chamber 29c (switched to a fail state “x”) when the level of the hydraulic pressure corresponding to the signal of the solenoid valve 32b is lower than the level of the biasing force generated by the spring 29b. Other configurations and actuations of the fail valve 29 are basically similar to those of the fail valve (29 in FIG. 1) in the first embodiment.

The solenoid valve 32b is a linear solenoid valve that is adapted to control a hydraulic pressure applied to the hydraulic pressure chamber 29c of the fail valve 29 on the basis of the electric current supplied thereto. The solenoid valve 32b is a normally low (NL) valve. Specifically, the solenoid valve 32b is configured to output a hydraulic pressure corresponding to the modulator pressure (P_{mod}) or output a hydraulic pressure by reducing the modulator pressure (P_{mod}) when the electric current is supplied to the solenoid valve 32b (e.g., an energized state). Further, the solenoid valve 32b is configured not to output the hydraulic pressure when the electric current is not supplied to the solenoid valve 32b (e.g., a non-energized state). The solenoid valve 32b is controlled by the electric control unit 35.

Actuations of the hydraulic pressure control apparatus for the hydraulic power transmission in the third embodiment are basically similar to those in the first embodiment except that the solenoid valve 32b has the normally low (NL) characteristic.

The hydraulic pressure control apparatus for the hydraulic power transmission in the third embodiment is configured to correspond to the multi-plate type impeller clutch 13a, however, the hydraulic pressure control apparatus in the third embodiment may be adapted to control the single-plate type impeller clutch (13b in FIG. 2) in the second embodiment. In this case, in order to engage the single-plate type impeller clutch (13b in FIG. 2), the impeller clutch controlling valve (31b in FIG. 2) having the normally low (NL) characteristic or the lock-up clutch controlling valve (33b in FIG. 2) having the normally low (NL) characteristic is actuated so that the level of the hydraulic pressure within the impeller clutch hydraulic presser chamber R3 is lower than that in the hydraulic pressure transmitting chamber R1.

According to the third embodiment, in the same manner as in the first embodiment, even when a failure occurs at the impeller clutch controlling valve 31a, the fail valve 29 or the solenoid valve 32b, the impeller clutch may be controlled so as to be in the engaged/disengaging state in the same manner as the normal operation, accordingly a loss of fuel economy may be prevented. Further, even when the electric power supply malfunctions so as not to supply the electric power to the electronic control unit 35 or the like, the impeller clutch 13a is engaged so that a situation where the vehicle is not able to be driven may be avoided.

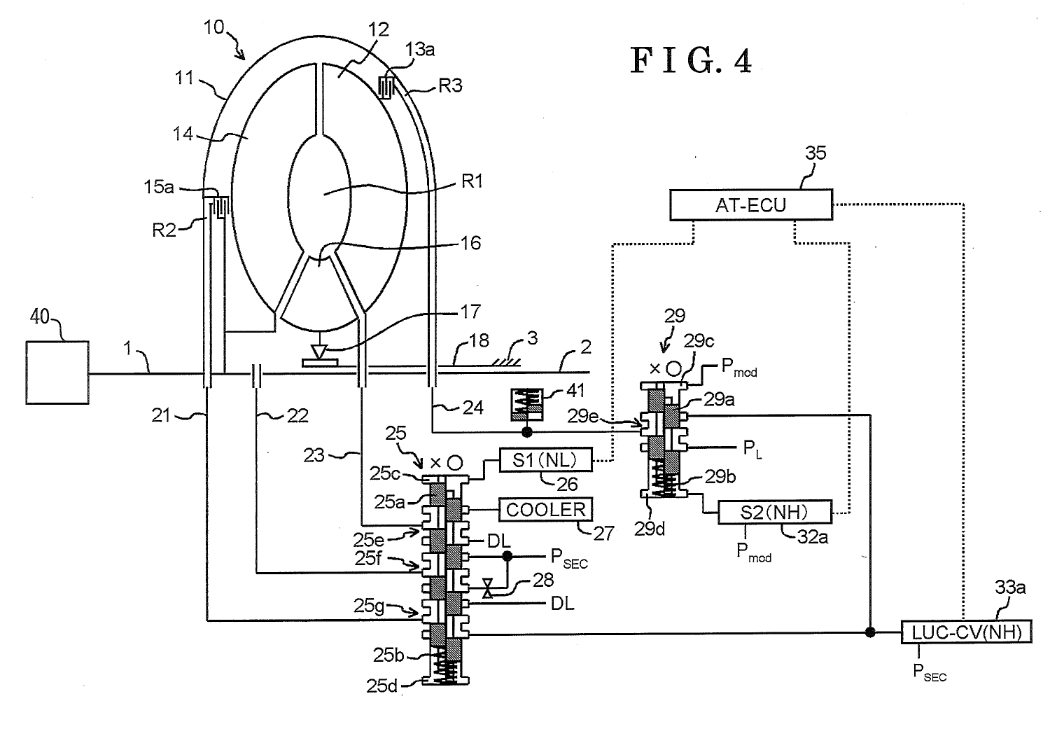

The hydraulic pressure control apparatus for the hydraulic power transmission of a fourth embodiment related to this disclosure will be described in accordance with the attached drawings. FIG. 4 illustrates a configuration diagram schematically indicating the hydraulic pressure control apparatus for the hydraulic power transmission in the fourth embodiment.

In the first embodiment, the impeller clutch controlling valve (31a in FIG. 1) is connected to the switching portion (29e in FIG. 1) of the fail valve (29 in FIG. 1), however, in the fourth embodiment, a hydraulic pressure source such as a line pressure (P_{L}) or the secondary pressure (P_{SEC}) is connected to the switching portion 29e of the fail valve 29, and an accumulator 41 is connected to the impeller clutch fluid passage 24. The hydraulic pressure control apparatus for the hydraulic power transmission is configured to correspond to a multi-plate type impeller clutch 13a, and the lock-up clutch controlling valve 33a has a normally high (NH) characteristic in the same manner as the first embodiment.

The accumulator 41 is an apparatus for absorbing hydraulic pressure changes rapidly generated at the impeller clutch fluid passage 24, and the accumulator 41 may be selectively connected to the impeller clutch fluid passage 24.

Actuations of the hydraulic pressure control apparatus for the hydraulic power transmission in the fourth embodiment are basically similar to those in the first embodiment except that the hydraulic pressure from the hydraulic pressure source (e.g., the line pressure (P_{L} or the secondary pressure (P_{SEC})) is applied to the switching portion 29e of the fail valve 29.

Further, in the fourth embodiment, the fluid passage connected to the impeller clutch fluid passage 24 is selected by applying the modulator pressure (P_{mod}) to the hydraulic pressure chamber 29c of the fail valve 29 or by applying the hydraulic pressure corresponding to the signal of the solenoid valve 32a having a normally high (NH) characteristic to the spring chamber 29d. Alternatively, the hydraulic pressure source such as the line pressure (P_{L} or the secondary pressure (P_{SEC}) may be connected to the switching portion (29e in FIG. 3) of the fail valve (29 in FIG. 3) in stead of the impeller clutch controlling valve (31a in FIG. 3) in the third embodiment, and the accumulator (41 in FIG. 4) is connected to the impeller clutch fluid passage (24 in FIG. 3) in the third embodiment.

According to the fourth embodiment, in the same manner as in the first embodiment, even when a failure occurs at the impeller clutch controlling valve 31a, the fail valve 29 or the solenoid valve 32a, the impeller clutch 13a may be controlled so as to be in the engaged/disengaging state in the same manner as the normal operation, accordingly a loss of fuel economy may be prevented. Further, even when the electric power supply malfunctions so as not to supply the electric power to the electronic control unit 35 or the like, the impeller clutch 13a is engaged so that a situation where the vehicle is not able to be driven may be avoided.

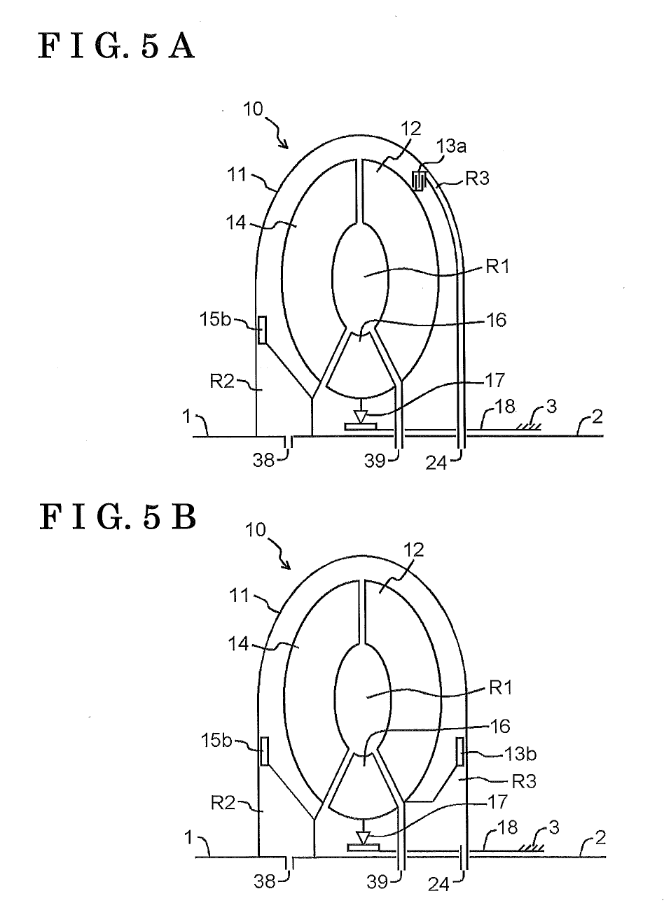

The hydraulic pressure control apparatus for the hydraulic power transmission of a fifth embodiment related to this disclosure will be described in accordance with the attached drawings. FIGS. 5A and 5B each illustrates a configuration diagram schematically indicating a torque converter adapted to the hydraulic pressure control apparatus for the hydraulic power transmission in the fifth embodiment. FIG. 5A illustrates a torque converter having a single-plate type lock-up clutch and a multi-plate type impeller clutch, and FIG. 5B illustrates a torque converter having a single-plate type lock-up clutch and a single-plate type impeller clutch.

In the first through fourth embodiments, the hydraulic pressure control apparatus for the hydraulic power transmission corresponds to the multi-plate type lock-up clutch (15a in FIGS. 1 through 4). In the fifth embodiment, a hydraulic power transmission (torque converter 10) including a single-plate type lock-up clutch 15b, which is replaceable to the hydraulic power transmission in each of the first through fourth embodiments, is used. Specifically, the torque converter 10 including the multi-plate type impeller clutch in each of the first, third and fourth embodiments may be replaced by the torque converter 10 in the fifth embodiment indicated in the drawing of FIG. 5A, and the torque converter 10 including the single-plate type impeller clutch in the second embodiment may be replaced by the torque converter 10 in the fifth embodiment indicated in the drawing of FIG. 5B.

The torque converter 10 in each of FIGS. 5A and 5B includes the single-plate type lock-up clutch 15b that eliminates the rotational speed difference between the power source (e.g., engine) 40 and the turbine runner 14 by directly connecting the pump impeller 12 to the turbine runner 14 when the rotational speed difference between the pump impeller 12 and the turbine runner 14 is small. When the lock-up clutch 15b is engaged, torque of the converter shell 11 is transmitted to the turbine runner 14. The lock-up clutch 15b includes a single-plate type clutch plate fixed to a member integrally rotating with the turbine runner 14. When a level of hydraulic pressure in the hydraulic power transmitting chamber R1 is higher than that in the lock-up clutch hydraulic pressure chamber R2, the clutch plate pressingly contacts an inner wall surface of the converter shell 11 so as to be frictionally engagable for establishing the engaging state. On the other hand, when the level of the hydraulic pressure in the lock-up clutch hydraulic pressure chamber R2 is higher than that in the hydraulic power transmitting chamber R1, the clutch plate disengages from the converter shell 11 so as to be relatively rotatable for establish an disengaging state. The hydraulic pressure in the hydraulic power transmitting chamber R1 is controlled by use of a lock-up on passage 39, and the hydraulic pressure in the lock-up clutch hydraulic pressure chamber R2 is controlled by use of a lock-up off passage 38. Other configurations of the torque converter 10 in the fifth embodiment are basically similar to those of the torque converter in each of the first through fourth embodiments.

An actuation and its results of the hydraulic pressure control apparatus in the fifth embodiment are similar to those in the first through fourth embodiments. Because of the single plate type lock-up clutch 15b of the hydraulic power transmission, only three fluid passages are required to establish the lock-up clutch control, the fluid transmission, and the impeller clutch control, in the same manner as the torque converter disclosed in JP2003-42287A (see FIG. 4), thereby reducing the number of parts of the hydraulic pressure control apparatus. Even when the hydraulic power transmission includes the multi-plate type lock-up clutch 15a that requires four fluid passages to establish those controls as in each of the first through fourth embodiments, although the number of parts is increased, the hydraulic power transmission may transmit a torque whose level is relatively high.

According to the abovementioned embodiments, because the pump impeller is surely connected to the power source even when the electric power supply malfunctions, a situation where the vehicle is not able to be driven may be avoided, thereby increasing a level of safety. Further, even when a failure occurs at at least one of the valves (e.g., the lock-up clutch controlling valve, the impeller clutch controlling valve, the fail valve or the solenoid valve), the impeller clutch may be controlled so as to be in the engaged/disengaging state in the same manner as the normal operation, accordingly a loss of fuel economy may be prevented.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A hydraulic pressure control apparatus for a hydraulic power transmission, the hydraulic power transmission including a pump impeller configured to rotate, a turbine runner configured to rotate in response to fluid transmitted from the pump impeller, a lock-up clutch adapted to directly connect the turbine runner to a power source and an impeller clutch adapted to disconnect the pump impeller from the power source, wherein the hydraulic pressure control apparatus comprises a switching valve provided at a fluid passage connecting the impeller clutch and a hydraulic pressure source and selectively connecting the impeller clutch to one of the hydraulic pressure source and a first control valve controlling a hydraulic pressure applied to the lock-up clutch.

2. The hydraulic pressure control apparatus for the hydraulic power transmission according to claim 1 further including a first solenoid valve controlling the switching valve by use of a hydraulic pressure so as to connect the impeller clutch to the hydraulic pressure source when the first solenoid valve is in an energized state and to connect the impeller clutch to the first control valve when the first solenoid valve is in a non-energized state.

3. The hydraulic pressure control apparatus for the hydraulic power transmission according to claim 1 further including a second control valve provided at a fluid passage between the switching valve and the hydraulic pressure source for controlling the hydraulic pressure of the hydraulic pressure source.

4. The hydraulic pressure control apparatus for the hydraulic power transmission according to claim 3, wherein the impeller clutch is a multi-plate type clutch, and each of the first control valve and the second control valve is a normally high control valve for outputting a reduced hydraulic pressure or not outputting a hydraulic pressure when the normally high control valve is in an energized state and for outputting a hydraulic pressure when the normally high control valve is in a non-energized state.

5. The hydraulic pressure control apparatus for the hydraulic power transmission according to claim 3, wherein the impeller clutch is a single-plate type clutch, and each of the first control valve and the second control valve is a normally low control valve for outputting a reduced hydraulic pressure when the normally low control valve is in an energized state and for not outputting a hydraulic pressure when the normally low control valve is in a non-energized state.

6. The hydraulic pressure control apparatus for the hydraulic power transmission according to claim 1 further including an accumulator provided at a fluid passage between the impeller clutch and the switching valve for absorbing a hydraulic pressure change applied to the impeller clutch.

7. The hydraulic pressure control apparatus for the hydraulic power transmission according to claim 1 further including a relay valve provided at a fluid passage between the lock-up clutch and the first control valve for selectively connect the lock-up clutch to one of the first control valve and a drain port.

8. The hydraulic pressure control apparatus for the hydraulic power transmission according to claim 7 further including a second solenoid valve for controlling the relay valve by use of a hydraulic pressure so as to connect the lock-up clutch to the first control valve when the second solenoid valve is in an energized state and to connect the lock up-clutch to the drain port when the second solenoid valve is in a non-energized state.

9. The hydraulic pressure control apparatus for the hydraulic power transmission according to claim 8 further including an electronic control unit for controlling the second solenoid valve so as to disconnect the first control valve from the lock-up clutch when the impeller clutch is controlled by use of the hydraulic pressure from the first control valve.

10. The hydraulic pressure control apparatus for the hydraulic power transmission according to claim 1, wherein the lock-up clutch is one of a multi-plate type clutch and a single-plate type clutch.

11. The hydraulic pressure control apparatus for the hydraulic power transmission according to claim 2 further including a second control valve provided at a fluid passage between the switching valve and the hydraulic pressure source for controlling the hydraulic pressure of the hydraulic pressure source.

12. The hydraulic pressure control apparatus for the hydraulic power transmission according to claim 11, wherein the impeller clutch is a multi-plate type clutch, and each of the first control valve and the second control valve is a normally high control valve for outputting a reduced hydraulic pressure or not outputting a hydraulic pressure when the normally high control valve is in an energized state and for outputting a hydraulic pressure when the normally high control valve is in a non-energized state.

13. The hydraulic pressure control apparatus for the hydraulic power transmission according to claim 11, wherein the impeller clutch is a single-plate type clutch, and each of the first control valve and the second control valve is a normally low control valve for outputting a reduced hydraulic pressure when the normally low control valve is in an energized state and for not outputting a hydraulic pressure when the normally low control valve is in a non-energized state.
